(19) United States
(12) Patent Application Publication
(10) Pub. No.: US 2021/0180669 A1
(43) Pub. Date: Jun. 17, 2021

(54) ATTACHMENT OF ENGINE-CONNECTING LUG TO TORQUE CONVERTER COVER

(71) Applicant: SCHAEFFLER TECHNOLOGIES AG & CO. KG, HERZOGENAURACH (DE)

(72) Inventor: Long SOUERS, North Canton, OH (US)

(73) Assignee: SCHAEFFLER TECHNOLOGIES AG & CO. KG, HERZOGENAURACH (DE)

(21) Appl. No.: 16/717,184

(22) Filed: Dec. 17, 2019

(51) Int. Cl. F16H 41/28; F16H 45/02

(52) U.S. Cl. CPC F16H 41/28; F16H 2041/243; F16H 45/02

(57) ABSTRACT

A torque converter includes an impeller and a cover non-rotatably fixed to the impeller. The cover has opposing inner and outer surfaces and a through hole extending from the inner surface to the outer surface. A lug has a collar adjacent the outer surface, a shank extending from a first side of the collar, and a stem extending from a second side of the collar. The stem is disposed in the hole and attached to the cover by a connection.

### TECHNICAL FIELD

The present disclosure relates to torque converters and more specifically to connections between the torque converter and an engine.

### BACKGROUND

Automatic transmissions may include a torque converter for coupling a transmission input shaft to a crankshaft of an engine. The torque converter may include an impeller fixed to the crankshaft, a turbine fixed to the input shaft, and a stator disposed between the impeller and the turbine. The torque converter may also include a bypass clutch to mechanically couple the transmission input shaft to the case of the torque converter, which is fixed to the crankshaft.

### SUMMARY

According to one embodiment, a torque converter includes an impeller and a cover non-rotatably fixed to the impeller. The cover has opposing inner and outer surfaces and a through hole extending from the inner surface to the outer surface. A lug has a collar adjacent the outer surface, a shank extending from a first side of the collar, and a stem extending from a second side of the collar. The stem is disposed in the hole and attached to the cover by a connection. The connection may be a weld.

According to another embodiment, a torque converter includes an impeller having a shell and impeller blades fixed to an inside surface of the shell. The torque converter further includes a turbine configured to fluidly couple with the impeller. A cover is non-rotatably fixed to the impeller. The cover has opposing inner and outer surfaces and defines a plurality of circumferentially arranged through holes having sidewalls extending from the inner surface to the outer surface. A plurality of lugs are configured to connect the cover to a flex plate. Each of the lugs has a shank and a stem. The stems are disposed in corresponding ones of the holes such that the shanks extend from the outer surface of the cover. The stems are attached to the cover by coalescence between the stems and the sidewalls.

According to yet another embodiment, a method includes providing a cover having opposing inner and outer surfaces and a through hole extending from the inner surface to the outer surface. The method further includes installing a lug on the cover by inserting a stem of the lug into the hole such that a shank of the lug projects from the outer surface. The method also includes welding the stem to a sidewall of the hole such that a weld completely encircles the stem to attach the lug to the cover and seal the hole.

### BRIEF DESCRIPTION OF THE DRAWINGS

FIG. 1 is a cross-sectional view of a torque converter.

FIG. 2 is a flow chart illustrating a method of assembling a torque converter.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Directional terms used herein are made with reference to the views and orientations shown in the exemplary figures. A central axis is shown in the figures and described below. Terms such as “outer” and “inner” are relative to the central axis. For example, an “outer” surface means that the surfaces faces away from the central axis, or is outboard of another “inner” surface. Terms such as “radial,” “diameter,” “circumference,” etc. also are relative to the central axis. The terms “front,” “rear,” “upper” and “lower” designate directions in the drawings to which reference is made.

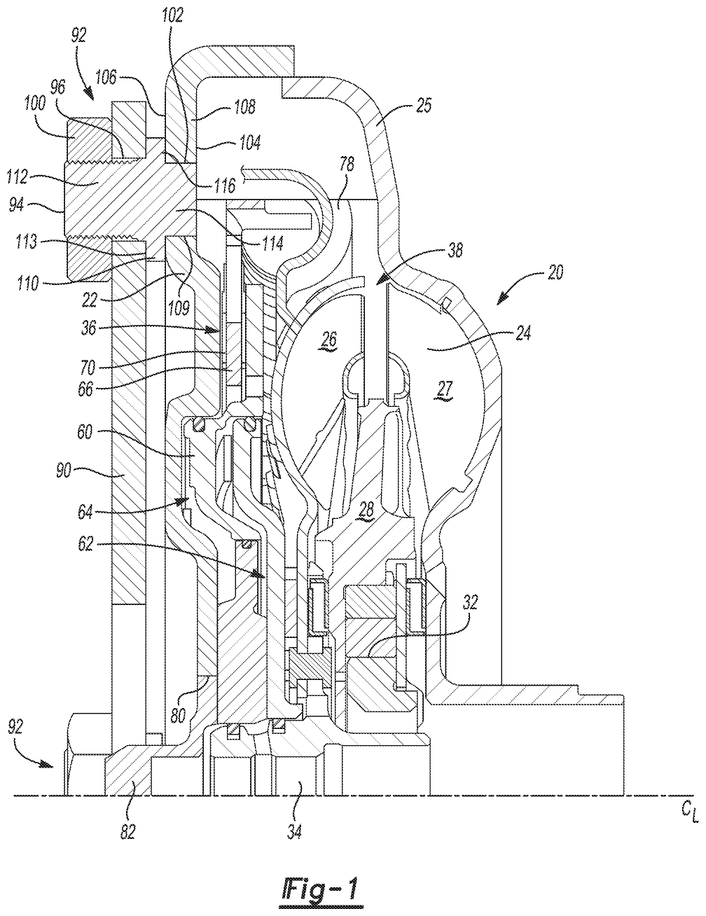

Referring to FIG. 1, a torque converter 20 may be used in a vehicle to couple an automatic transmission to a powerplant, e.g., an engine. For example, the torque converter 20 includes a cover 22 non-rotationally fixed to a crankshaft of the engine. Components that are non-rotationally fixed rotate in unison. An impeller 24 is fixed to the cover 22 and rotates with the crankshaft. The impeller 24 may include a shell 25 and blades 27. The shell 25 is attached to the cover 22 and forms the back portion of the outer housing of the torque converter 20. A turbine 26 is disposed adjacent to the impeller 24 within a hydrodynamic chamber 38 of the torque converter 20. The turbine 26 is attached to a turbine hub 34 that is connected, e.g., splined, to a transmission input shaft that supplies power to the transmission.

A stator 28 is coupled to a stator shaft (not shown) by a one-way clutch 32. The stator shaft is fixed to a front support of the transmission and is stationary relative to the torque converter 20. When the transmission input shaft is stationary or rotating slowly compared to the crankshaft, the one-way clutch 32 holds the stator 28 stationary. Rotation of the impeller 24 forces fluid to move between the impeller 24, the turbine 26, and the stator 28. The fluid exerts a hydrodynamic torque on the turbine 26. The stator 28 provides a reaction force causing the torque on the turbine 26 to be greater than the torque on the impeller 24. When the speed of the turbine 26 approaches that of the impeller 24, fluid tends to flow around the centerline of the torque converter, causing the one-way clutch 32 to overrun.

The torque converter 20 may include a bypass clutch 36 that mechanically connects the turbine 26 to the cover 22 to bypass the hydrodynamic power flow path of the torque converter 20. The bypass clutch 36 is often engaged during cruise to improve fuel efficiency. The bypass clutch 36 may include a clutch disc 66 operated by a clutch piston 60. The clutch disc 66 may include at least one friction material 70 disposed thereon. The clutch disc 66 is sandwiched between the clutch piston 60 and the cover 22. The clutch 36 is engaged by moving the clutch piston 60 towards the cover 22 to frictionally lock the clutch disc 66 to the cover 22. The turbine 26 is fixed to the clutch disc 66 by a damper 78. Thus, the turbine 26 is fixed to the cover 22 when the bypass clutch 36 is fully engaged to bypass the hydrodynamic power flow path and instead mechanically couple the engine to the transmission. Other bypass clutch designs may be used in the torque converter 20.

The clutch piston 60 may be hydraulically actuated by supplying fluid, e.g., oil, to an apply chamber 62 or a compensation chamber 64. The apply chamber 62 and the compensation chamber 64 may be fluidly isolated from the hydrodynamic chamber 38 and from each other. Two chambers may be considered to be fluidly isolated if they are capable of having meaningfully different pressures. The torque converter 20 includes components that cooperate to define the apply chamber 62 and the compensation chamber 64.

The cover 22 defines a circular cutout 80 that seats on a ledge of a cover pilot 82. The cover 22 may be joined to the cover pilot 82 by welding such as laser welding. The cover pilot 82, inter alia, supports the turbine hub 34 and may define fluid passageways for operation of the bypass clutch 36 (if provided).

The cover 22 is connected to the crankshaft of the engine via a flywheel or the illustrated flex plate 90. The flex plate 90 is connected to the cover 22 via a plurality of fastener connections 92. In the illustrated embodiment, the cover 22 includes a plurality of lugs 94 that are inserted through holes 96 defined in the flex plate 90. The diameters of the holes may substantially equal to diameters of the lugs 94, albeit slightly larger to provide clearance for insertion. The cover 22 is connected to the flex plate 90 by inserting the lugs 94 through the holes 96 and securing fasteners 100, e.g., nuts, on the lugs 94.

The cover 22 may be formed as a stamping. Holes 102 are defined through a front face 108 of the cover 22. The holes 102 are completely through the cover 22 and extend from the interior surface 104 to the exterior surface 106. The holes 102 may be circular to match the circular lugs 94. The lugs 94 and the holes 96, 102, however, may include other cross-sectional shapes in other embodiments. The holes 102 are arranged in a circumferential array on the front face 108. The holes 102 may have equal angular spacing relative to each other and may lie on a common circle. For example, the cover 22 may define four holes equally spaced at 90 degrees. The number of holes, and by extension, the number of lugs, may vary based on the strength requirements of the application. A range of four to six lugs/holes is suitable for most applications.

Each lug 94 may include a collar 110, a shank 112 extending from a first side 113 of the collar 110, and a stem 114 extending from a second side 116 of the collar 110. The shank 112 is designed to connect with the flex plate 90, e.g., be received within the holes 96 of the flex plate and secure thereto, and the stem 114 is designed to be connected to the cover 22. The lug 94 may be cylindrical with the collar 110 having a larger diameter than the shank 112, the stem 114, and the hole 102. The shank 112 may be longer than the stem 114. In some embodiments, the collar 110 may not be present, and the flex plate is disposed against the cover 22.

The lugs 94 may be connected to the cover 22 by inserting the stems 114 into the holes 102 and then welding the lugs 94 to the cover 22. When installed, the second sides 116 of the collars 110 are adjacent the exterior surface 106. The stems 114 may have a length that is equal to the thickness of the front face 108 or may be longer or short than the thickness in other embodiments. In one or more embodiment, the lugs 94 are laser welded to the cover 22. Each laser weld creates coalescence between the sidewall 109 of the hole 102 and the stem 114. The welds may completely encircle the stems 114 to seal the holes 102 and prevent fluid within the torque converter 20 from leaking.

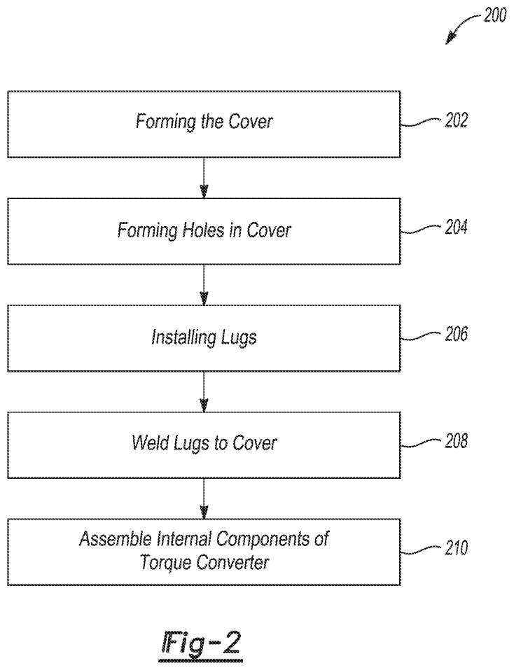

Described below are example methods of assembling a torque converter using CD welding. Referring to the flow chart of FIG. 2 and FIG. 1, a method 200 of assembling a torque converter includes forming a cover at operation 202. For easy of description, the method will be described in conjunction with the illustrated embodiment, but the method is not limited thereto. The cover 22 may be formed by a stamping operation. The stamping process may be performed in one or more steps. Once the cover 22 is stamped, one or more secondary operations may be performed. For example, the holes 96 may be formed through the front face 108. The holes 102 may be formed by drilling, punching, and the like at operation 204. In some embodiment, the holes 96 may be formed during the stamping operation 202. At operation 206, the lugs 94 are installed on the cover by inserting the stems 114 of the lugs into the holes 102 such that the shanks 112 of the lug project from the outer surface of the cover 22. The collars 110 may be disposed tightly against the exterior surface 106 of the cover 22. Once the lugs 94 are installed, a welding tool, such as a laser welder or a metal inert gas (MIG) welder, welds the stems 114 of the lugs to the cover 22. The welding tool may be applied around the collar 110. In the case of a laser welder, heat from the laser will melt the stem 114 and the sidewall of the hole 102 to form coalescence. The laser welder may be rotated completely around the lug so that the weld encircles the stem 114 to seal the hole 102 and inhibit leaking. In the case of MIG welding, the welding tool is applied on the back side of the front face 108 and weld material is flowed towards the collar 110.

After the lugs 94 are welded, the remaining components, e.g., impeller, turbine, stator, bypass clutch, etc., of the torque converter 20 may be assembled to form a completed torque converter assembly at operation 210. During later installation of the torque converter to the engine, the lugs will be inserted through holes of the flex plate and a retainer, such as a nut, will be driven down onto the studs to connect the torque converter to the crankshaft the engine.

The above-discussed method steps are not an exhaustive list of all steps for fully assembling a torque converter and instead explain a representative basis for employing internally welded lugs used for connecting the cover to the flex plate. While the method steps are described in a particular sequence, the steps may be performed in other sequences and some steps may be omitted in some embodiments.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

The following is a list of reference numbers shown in the Figures. However, it should be understood that the use of these terms is for illustrative purposes only with respect to one embodiment. And, use of reference numbers correlating a certain term that is both illustrated in the Figures and present in the claims is not intended to limit the claims to only cover the illustrated embodiment.

### PARTS LIST

20 torque converter
22 cover
24 impeller
25 shell
26 turbine
27 blades
28 stator
32 one-way clutch
34 turbine hub
36 bypass clutch
38 hydrodynamic chamber
60 clutch piston
62 apply chamber
64 compensation chamber
66 clutch disc
70 friction material
78 damper
80 circular cutout
82 cover pilot
90 flex plate
92 fastener connections
94 lugs
96 holes
100 fasteners
102 holes
104 interior surface
106 exterior surface
108 front face
109 sidewall
110 collar
112 shank
113 first side
114 stem
116 second side

What is claimed is:

1. A torque converter comprising:
an impeller;
a cover non-rotatably fixed to the impeller, the cover including opposing inner and outer surfaces and a through hole extending from the inner surface to the outer surface; and
a lug including a collar adjacent the outer surface, a shank extending from a first side of the collar, and a stem extending from a second side of the collar, wherein the stem is disposed in the hole and attached to the cover by a connection.

2. The torque converter of claim 1, wherein the hole is a plurality of holes circumferentially arranged around the cover, and wherein the lug is a plurality of lugs.

3. The torque converter of claim 1, wherein the shank is threaded.

4. The torque converter of claim 1, wherein the lug is cylindrical, and the collar has a larger diameter than the shank, the stem, and the hole.

5. The torque converter of claim 1, wherein the connection completely encircles the stem to seal the hole.

6. The torque converter of claim 1, wherein the connection is a weld between the stem and a sidewall of the hole.

7. The torque converter of claim 6, wherein the weld is a laser weld.

8. The torque converter of claim 1 further comprising:
a flex plate defining another hole that receives the shank therein; and
a retainer disposed on the shank to retain the flex plate to the cover.

9. The torque converter of claim 1, wherein the shank is longer than the stem.

10. A torque converter comprising:
an impeller including a shell and impeller blades fixed to an inside surface of the shell;
a turbine configured to fluidly couple with the impeller;
a cover non-rotatably fixed to the impeller, the cover including opposing inner and outer surfaces and defining a plurality of circumferentially arranged through holes having sidewalls extending from the inner surface to the outer surface; and
a plurality of lugs configured to connect the cover to a flex plate, each of the lugs including a shank and a stem, wherein the stems are disposed in corresponding ones of the holes such that the shanks extend from the outer surface of the cover, and the stems are attached to the cover by coalescence between the stems and the sidewalls.

11. The torque converter of claim 10, wherein each of the lugs includes a collar disposed between the shank and the stem.

12. The torque converter of claim 11, wherein the lugs are cylindrical, and the collars have a larger diameter than the shanks, the stems, and the holes.

13. The torque converter of claim 12, wherein diameters of the holes are substantially equal to diameters of the stems.

14. The torque converter of claim 10, wherein the coalescence between the stems and the sidewalls are welds.

15. The torque converter of claim 14, wherein each of the welds completely encircles a corresponding one the stems to seal the corresponding ones of the holes.

16. The torque converter of claim 10, wherein the holes are equally angularly spaced from each other.

17. The torque converter of claim 10, wherein the shanks are threaded and are longer than the stems.

18. A method comprising:
providing a cover having opposing inner and outer surfaces and a through hole extending from the inner surface to the outer surface;
installing a lug on the cover by inserting a stem of the lug into the hole such that a shank of the lug projects from the outer surface; and
welding the stem to a sidewall of the hole such that a weld completely encircles the stem to attach the lug to the cover and seal the hole.

19. The method of claim 18, wherein the lug includes a collar disposed between the shank and the stem, wherein the installing the lug on the cover further includes placing the collar against the outer surface.

20. The method of claim 18 further comprising attaching a flex plate, having a hole, to the cover by inserting the shank through the hole of the flex plate and securing a retainer to the shank.
